(19) United States
(12) Patent Application Publication
(10) Pub. No.: US 2024/0376824 A1
(43) Pub. Date: Nov. 14, 2024

(54) GAS TURBINE AIRFOIL NOISE REDUCTION

(71) Applicant: General Electric Company, Schenectady, NY (US)

(72) Inventors: Balaraju Suresh, Bengaluru (IN); Guru Venkata Dattu Jonnalagadda, Ponnur (IN); Trevor Howard Wood, Clifton Park, NY (US); Nicholas Joseph Kray, Mason, OH (US); Vishnu Vardhan Venkata Tatiparthi, Bengaluru (IN); Nitesh Jain, Bengaluru (IN)

(21) Appl. No.: 18/314,244

(22) Filed: May 9, 2023

(51) Int. Cl. F01D 5/14

(52) U.S. Cl. CPC F01D 5/141; F05D 2220/323; F05D 2220/36; F05D 2240/305; F05D 2240/306; F05D 2260/961

(57) ABSTRACT

An airfoil for a turbofan engine includes a first contoured sidewall, a second contoured sidewall, a leading edge, and a trailing edge with each extending in a spanwise direction defined between a root and a tip portion of the airfoil. The first contoured sidewall and the second contoured sidewall define an outer surface of the airfoil. The airfoil further includes a plurality of protrusions where each protrusion of the plurality of protrusions has a curvilinear shape and extends outwardly from the outer surface along at least one of the first contoured sidewall or the second contoured sidewall. The plurality of protrusions is defined downstream from a mid-point of a chord length of the airfoil and terminates upstream of the trailing edge.

### FIELD

The present disclosure relates to an airfoil for a turbofan engine and more particularly, to reducing airfoil noise.

### BACKGROUND

Gas turbine engines, such as turbofan engines, may be used for aircraft propulsion. A turbofan engine generally includes a fan and a gas turbine engine or core engine to drive the fan. The turbofan engine includes various components which include airfoils such as fan blades, compressor stators, compressor blades, turbine stators, turbine blades, inlet and outlet guide vanes and exhaust nozzle vanes. Significant noise, including both trailing-edge self-noise and wake interaction noise, is generated at or downstream of a trailing edge of an airfoil. Self-noise is generally the result of an interaction between turbulence in a boundary layer formed by air flow across the airfoil and an edge discontinuity created or formed at the trailing edge of the airfoil whereas interaction noise is generated by the wakes connecting downstream and impinging upon structures downstream in the fan wakes, such as stationary outlet guide vanes (OGVs). This interaction converts near-field pressure fluctuations to acoustic waves which propagate from the turbofan engine to the environment.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a perspective view of an exemplary aircraft in accordance with an exemplary aspect of the present disclosure.

FIG. 2 is a cross-sectional view of an exemplary turbofan engine in accordance with an exemplary aspect of the present disclosure.

FIG. 3 is a perspective view of an exemplary airfoil, in accordance with an exemplary aspect of the present disclosure.

FIG. 4 is a cross-sectional top view of the airfoil as shown in FIG. 3, taken along section line 4-4, in accordance with an exemplary aspect of the present disclosure.

FIG. 5 is a perspective view of an exemplary airfoil, in accordance with an exemplary aspect of the present disclosure.

FIG. 6 is a cross-sectional view of a portion of the airfoil as shown in FIG. 5 taken along section line 6-6, in accordance with an exemplary aspect of the present disclosure.

FIG. 7 is a perspective view of an exemplary airfoil illustrating a pair of exemplary protrusions formed along a surface of the airfoil, in accordance with an exemplary aspect of the present disclosure.

FIG. 8 is a schematic partial cross-sectional view taken along section line 8-8 of FIG. 7 illustrating pairs of exemplary protrusions formed along a surface of an airfoil, in accordance with an exemplary aspect of the present disclosure.

FIG. 9 is a schematic top-down view of an exemplary protrusion according to exemplary embodiments of the present disclosure.

FIG. 10 is a topographic view of the exemplary protrusion shown in FIG. 9, taken along elevation lines “A”, “B”, and “C”, according to exemplary embodiments of the present disclosure.

FIG. 11 is a top-down view of a plurality of exemplary protrusions according to an exemplary embodiment of the present disclosure.

FIG. 12 is a schematic top-down view of a pair of exemplary protrusions according to an exemplary embodiment of the present disclosure.

FIG. 13 a schematic top-down view of a pair of exemplary protrusions according to an exemplary embodiment of the present disclosure.

Repeat use of reference characters in the present specification and drawings is intended to represent the same or analogous features or elements of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary. The singular forms “a”, “an”, and “the” include plural references unless the context clearly dictates otherwise. The term “at least one of” in the context of, e.g., “at least one of A, B, and C” refers to only A, only B, only C, or any combination of A, B, and C.

As used herein, the terms “first”, “second”, and “third” may be used interchangeably to distinguish one component from another and are not intended to signify location or importance of the individual components. Furthermore, the terms “upstream” and “downstream” refer to the relative direction with respect to fluid flow in a fluid pathway. For example, “upstream” refers to the direction from which the fluid flows, and “downstream” refers to the direction to which the fluid flows.

The term “turbomachine” refers to a machine including one or more compressors, a heat generating section (e.g., a combustion section), and one or more turbines that together generate a torque output. The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines. The term “curvilinear” generally refers to a shape that is bounded by curved lines and smooth edges.

As used herein, the terms “additively manufactured” or “additive manufacturing techniques or processes” refer generally to manufacturing processes wherein successive layers of material(s) are provided on each other to “build-up,” layer-by-layer, a three-dimensional component. The successive layers generally fuse together to form a monolithic component which may have a variety of integral sub-components. Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or manufacturing technology. For example, embodiments of the present disclosure may use layer-additive processes, layer-subtractive processes, or hybrid processes.

The present disclosure is generally related to an airfoil for a turbofan engine or turbomachine. As previously discussed, significant noise, commonly referred to as tailing-edge self-noise or wake interaction noise, is generated at or downstream of a trailing edge of an airfoil. Trailing edge self-noise is generally the result of an interaction between turbulence in a boundary layer formed by air flowing across the airfoil and an edge discontinuity created or formed at the trailing edge of the airfoil. Wake interaction noise in contrast occurs when the fan wakes convect and evolve downstream and impinge on aerodynamic surfaces downstream resulting in surface pressure fluctuations on those surfaces. This distribution of near-field pressure fluctuations results in acoustic waves which propagate from the turbofan engine to the environment.

The present disclosure is directed to protrusions having curvilinear shapes that are formed along a pressure sidewall or suction sidewall of an airfoil at a location that is downstream from a mid-point of the respective airfoils chord line and upstream from a trailing edge of the airfoil wherein the airfoil and the protrusions are formed as a unitary body. The protrusions, particularly when formed along the suction sidewall of the airfoil at the trailing edge region, encourage mixing of a wake generated at and evolving downstream from the trailing edge so that for a given spacing between sequential rows of rotors and stators (rotors and rotors for an open fan or contra rotating rows of turbo machinery blades), the interaction noise created by the wake will be quieter. The protrusions may be formed in such a way that the mixing or streamwise vortical mixing that these features provide reduces aero-acoustic and/or aero-mechanical response of a downstream aerodynamic surfaces.

The protrusions may be integrated/formed/blended along with the pressure sidewall and/or the suction sidewall of the airfoil in an aerodynamically smooth manner. A particular shape of one or more of the protrusions may be tailored to local boundary layer conditions along a particular surface or sidewall of the airfoil, resulting in improved mixing vorticity and reduced negative effects of the airfoil wake.

The curvilinear shape also allows for smoothly tapered fillets blending the surface of the protrusions and airfoil surface to enable wake mixing vorticity generation with a minimum in corner flow losses and associated drag. Further, three-dimensional (3D) shaping capability is provided so as to maximize the formation of streamwise vorticity through consideration of the flow velocity profile through the boundary layer at particular locations along the airfoil. For example, nearest the airfoil surface in an inner boundary layer region where the flow velocity is slowest, the airfoil section shapes are formed to be thicker, longer in chord, and progressively tapered to thinner, shorter chord shapes from a base to a tip of the protrusion located furthest from the nominal airfoil surface and positioned in a comparatively higher velocity portion of the boundary layer.

Further, the airfoil camber (curvature, or also described by the difference in tangent angles at a mean camber line between the leading and trailing edges of the feature) is highest nearest the wall and progressively tapered to reduce camber monotonically from base to tip of the features. This 3D shaping of the feature provides the ability to optimize a loading distribution of aerodynamic pressure on the surfaces of the protrusions to generate streamwise vorticity of sufficient strength to mix the wakes that emanate from the airfoil and impinge on aerodynamic surfaces downstream with less magnitude of unsteadiness as compared to a conventional airfoil, thereby reducing the aeromechanical and aeroacoustic response of the downstream surfaces to these modified airfoil wakes.

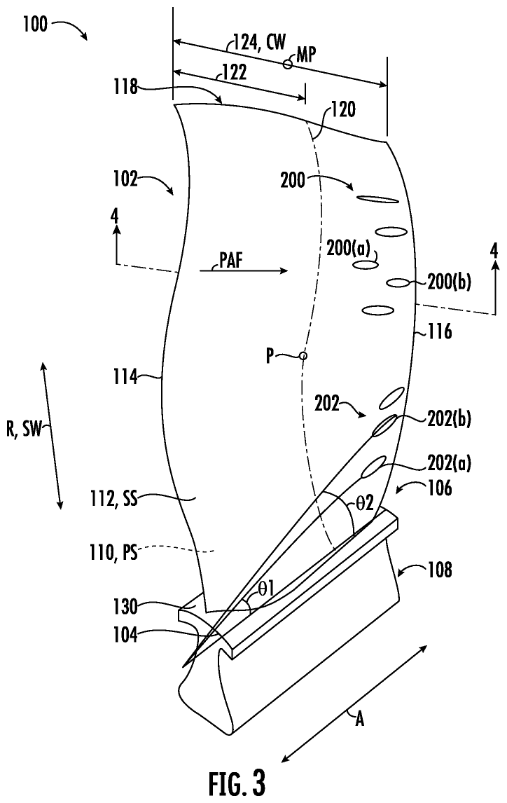

As shown in FIGS. 3-8 as described below, the curvature of the forming the protrusions and airfoil as a unitary body results in smooth surfaces leading up to and across the protrusions such that a pressure or concave side of the protrusions (as viewed by wall normal section cuts) is formed with a higher curvature (i.e., lower radius of curvature) than on a suction side of the protrusion, so as to efficiently maintain a higher local aerodynamic pressure on the concave sides of the feature and to smoothly guide the spanwise component of flow velocity up the suction sides of the protrusion to most efficiently form the streamwise vorticity.

Depending on the mixing approaches used to optimally mix the wakes for aeromechanics and/or aeroacoustics from the surfaces downstream of the airfoil, arrays of co-rotating or counter-rotating pairs of vortex generating protrusions may be employed. These arrays of protrusions can be formed of varying sizes and camber upstream of the trailing edge vs. closer to the trailing edge where the boundary layer is locally thicker on the suction side of the airfoil.

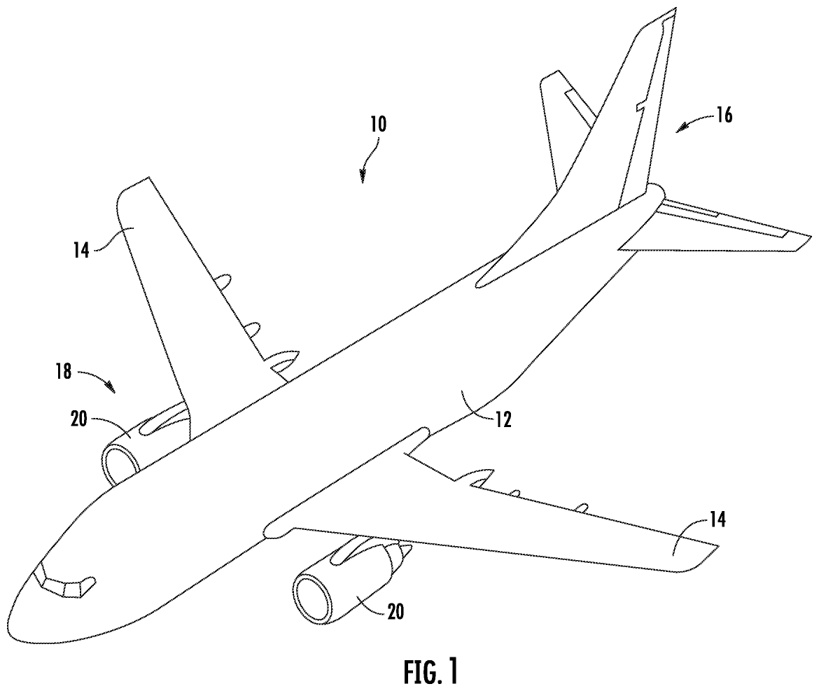

Referring now to the drawings, FIG. 1 is a perspective view of an exemplary aircraft (10) that may incorporate at least one exemplary embodiment of the present disclosure. As shown in FIG. 1, the aircraft 10 has a fuselage 12, wings 14 attached to the fuselage 12, and an empennage 16. The aircraft 10 further includes a propulsion system 18 that produces a propulsive thrust to propel the aircraft 10 in flight, during taxiing operations, etc. Although the propulsion system 18 is shown attached to the wing 14, in other embodiments it may additionally or alternatively include one or more aspects coupled to other parts of the aircraft 10, such as, for example, the empennage 16, the fuselage 12, or both.

The propulsion system 18 includes at least one engine. In the exemplary embodiment shown, the aircraft 10 includes a pair of turbofan engines 20. Each turbofan engine 20 is mounted to the aircraft 10 in an under-wing configuration. Each turbofan engine 20 is capable of selectively generating a propulsive thrust for the aircraft 10. The turbofan engines 20 may be configured to burn various forms of fuel including, but not limited to unless otherwise provided, jet fuel/aviation turbine fuel, and hydrogen fuel. Alternatively the fan portion of the engine may be powered by an electric motor in an electrically driven fan as opposed to a gas turbine.

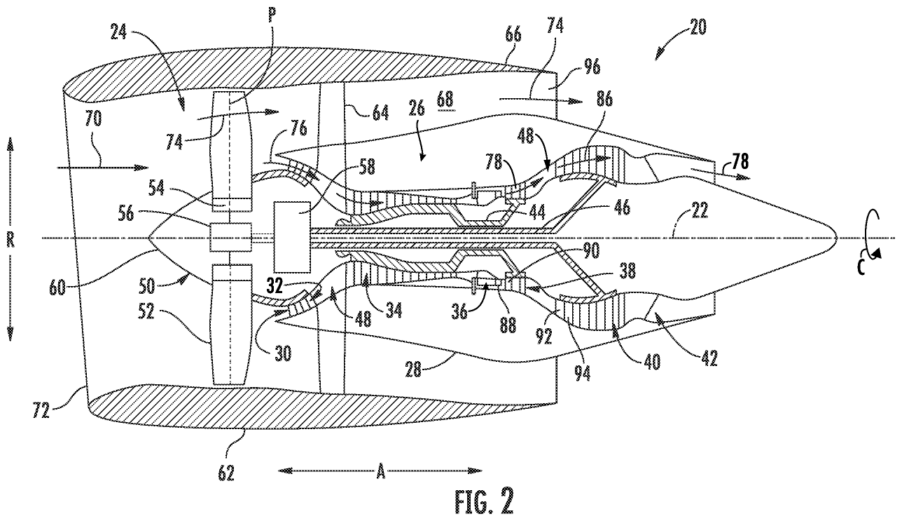

FIG. 2 is a cross-sectional side view of one of the turbofan engines 20 in accordance with an exemplary embodiment of the present disclosure. More particularly, for the embodiment of FIG. 2, the turbofan engine 20 is a multi-spool, high-bypass turbofan jet engine, sometimes also referred to as a “turbofan engine.” As shown in FIG. 2, the turbofan engine 20 defines an axial direction A (extending parallel to a longitudinal centerline 22 provided for reference), a radial direction R. and a circumferential direction C extending about the longitudinal centerline 22. In general, the turbofan engine 20 includes a fan section 24 and a turbomachine 26 disposed downstream from the fan section 24.

The turbomachine 26 depicted generally includes an outer casing 28 that defines an annular core inlet 30. The outer casing 28 at least partially encases, in serial flow relationship, an axial compressor section including a booster or low-pressure (LP) compressor 32 and a high-pressure (HP) compressor 34, a combustion section 36, a turbine section including a high-pressure (HP) turbine 38 and a low-pressure (LP) turbine 40, and a jet exhaust nozzle 42.

A high-pressure (HP) shaft 44 drivingly connects the HP turbine 38 to the HP compressor 34. A low-pressure (LP) shaft 46 that drivingly connects the LP turbine 40 to the LP compressor 32. The LP compressor 32, the HP compressor 34, the combustion section 36, the HP turbine 38, the LP turbine 40, and the jet exhaust nozzle 42 together define a working gas flow path 48 through the turbofan engine 20.

For the embodiment depicted, the fan section 24 includes a fan 50 having a plurality of fan blades 52 coupled to a disk 54 in a spaced apart manner. As depicted, the fan blades 52 extend outwardly from disk 54 generally along the radial direction R. Each fan blade 52 is rotatable with the disk 54 about a pitch axis P by virtue of the fan blades 52 being operatively coupled to a suitable pitch change mechanism 56 configured to collectively vary the pitch of the fan blades 52, e.g., in unison.

The turbofan engine 20 further includes a power gear box 58. The fan blades 52, disk 54, and pitch change mechanism 56 are together rotatable about the longitudinal centerline 22 by the LP shaft 46 across the power gear box 58. The power gear box 58 includes a plurality of gears for adjusting a rotational speed of the fan 50 relative to a rotational speed of the LP shaft 46, such that the fan 50 and the LP shaft 46 may rotate at more efficient relative speeds.

Referring still to the exemplary embodiment of FIG. 2, disk 54 is covered by a rotatable front hub 60 of the fan section 24 (sometimes also referred to as a “spinner”). The front hub 60 is aerodynamically contoured to promote an airflow through the plurality of fan blades 52. Additionally, the fan section 24 includes an annular fan casing or outer nacelle 62 that circumferentially surrounds the fan 50 and/or at least a portion of the turbomachine 26. The outer nacelle 62 is supported relative to the turbomachine 26 by a plurality of circumferentially spaced struts or outlet guide vanes 64 in the embodiment depicted. Moreover, a downstream section 66 of the outer nacelle 62 extends over an outer portion of the turbomachine 26 to define a bypass airflow passage 68 therebetween.

It should be appreciated, however, that the exemplary turbofan engine 20 depicted in FIG. 2 is provided by way of example only, and that in other exemplary embodiments, the turbofan engine 20 may have other configurations. For example, although the turbofan engine 20 depicted is configured as a ducted turbofan engine (i.e., including the outer nacelle 62), in other embodiments, the turbofan engine 20 may be an unducted or non-ducted turbofan engine (such that the fan 50 is an unducted fan, and the outlet guide vanes 64 are cantilevered from the outer casing 28).

Additionally, or alternatively, although the turbofan engine 20 depicted is configured as a geared turbofan engine (i.e., including the power gear box 58) and a variable pitch turbofan engine (i.e., including a fan 50 configured as a variable pitch fan), in other embodiments, the turbofan engine 20 may be configured as a direct drive turbofan engine (such that the LP shaft 46 rotates at the same speed as the fan 50), as a fixed pitch fan (such that the fan 50 includes fan blades 52 that are not rotatable about a pitch axis P), or both. It should also be appreciated, that in still other exemplary embodiments, aspects of the present disclosure may be incorporated into any other suitable turbofan engine. For example, in other exemplary embodiments, aspects of the present disclosure may (as appropriate) be incorporated into, e.g., a turboprop engine, a turboshaft engine, or a turbojet engine.

During operation of the turbofan engine 20, a volume of air 70 enters the turbofan engine 20 through an associated inlet 72 of the outer nacelle 62 and fan section 24. As the volume of air 70 passes across the fan blades 52, a first portion of air 74 is directed or routed into the bypass airflow passage 68 and a second portion of air 76 is directed or routed into the working gas flow path 48, or more specifically into the LP compressor 32. The ratio between the mass flow rate of the first portion of air 74 and that of the second portion of air 76 is commonly known as a bypass ratio.

As the second portion of air 76 enters the LP compressor 32, one or more sequential stages of low-pressure (LP) compressor stator vanes 78 and low-pressure (LP) compressor rotor blades 80 coupled to the LP shaft 46 progressively compress the second portion of air 76 flowing through the LP compressor 32 enroute to the HP compressor 34. Next, one or more sequential stages of high-pressure (HP) compressor stator vanes 82 and high-pressure (HP) compressor rotor blades 84 coupled to the HP shaft 44 further compress the second portion of air 76 flowing through the HP compressor 34. This provides compressed air to the combustion section 36 where it mixes with fuel and burns to provide combustion gases 86.

The combustion gases 86 are routed through the HP turbine 38 where a portion of thermal and/or kinetic energy from the combustion gases 86 is extracted via sequential stages of high-pressure (HP) turbine stator vanes 88 that are coupled to a turbine casing and high-pressure (HP) turbine rotor blades 90 that are coupled to the HP shaft 44, thus causing the HP shaft 44 to rotate, thereby supporting operation of the HP compressor 34. The combustion gases 86 are then routed through the LP turbine 40 where a second portion of thermal and kinetic energy is extracted from the combustion gases 86 via sequential stages of low-pressure (LP) turbine stator vanes 92 that are coupled to a turbine casing and low-pressure (LP) turbine rotor blades 94 that are coupled to the LP shaft 46, thus causing the LP shaft 46 to rotate, and thereby supporting operation of the LP compressor 32 and/or rotation of the fan 50.

The combustion gases 86 are subsequently routed through the jet exhaust nozzle 42 of the turbomachine 26 to provide propulsive thrust. Simultaneously, the pressure of the first portion of air 74 is substantially increased as it is routed through the bypass airflow passage 68 before it is exhausted from a fan nozzle exhaust section 96 of the turbofan engine 20, also providing propulsive thrust. The HP turbine 38, the LP turbine 40, and the jet exhaust nozzle 42 at least partially define a hot gas path 98 for routing the combustion gases 86 through the turbomachine 26.

FIG. 3 is a perspective view of one embodiment of fan blade 100 that may be used as a fan blade in turbofan engine 20 (shown in FIG. 2). In the exemplary embodiment, fan blade 100 includes an airfoil portion or airfoil 102, a platform 104, and a root portion 106. Alternatively, airfoil 102 may be used with, but not limited to, rotor blades, stator blades, and/or nozzle assemblies. In the exemplary embodiment, root portion 106 includes an integral dovetail 108 that enables fan blade 100 to be mounted to rotor disk 54 (FIG. 2). As shown in FIG. 3, airfoil 102 includes a first contoured sidewall 110 and a second contoured sidewall 112. Specifically, in the exemplary embodiment, first contoured sidewall 110 defines a pressure sidewall (PS) of fan blade 100, and second contoured sidewall 112 defines a suction sidewall (SS) of fan blade 100. First contoured sidewall 110, PS and second contoured sidewall 112, SS are coupled together at a leading edge 114 and at a trailing edge 116 that is axially-spaced from the leading edge 114. Trailing edge 116 is spaced chordwise and downstream from leading edge 114. The first contoured sidewall 110/pressure sidewall (PS) and second contoured sidewall 112/suction sidewall (SS) each extend spanwise (SW), or radially (R) outward, from root portion 106 to a tip portion 118.

In an exemplary embodiment, fan blade 100 also includes a camber and thickness variation or initiation line 120 extending in the spanwise direction from root portion 106 to tip portion 118. Initiation line 120 is spaced a chordwise distance 122 from leading edge 114. In one embodiment, chordwise distance 122 is between about 0% of a chord length 124 from the leading edge to about 90% of chord length 124. In an exemplary embodiment, chordwise distance 122 is about 60% of chord length 124. In an exemplary embodiment, a chordwise length of chord length 124 varies from root portion 106 to tip portion 118. Alternatively, fan blade 100 may have any conventional form, with or without dovetail 108 or platform 104. For example, fan blade 100 may be formed integrally with disk 54 (FIG. 2) in a blisk-type configuration that does not include dovetail 108 and the platform 104. The chord length 124 extends in and/or defines a chordwise direction (CW).

In exemplary embodiments, the airfoil 102 includes a plurality of protrusions 200 extending outwardly from the second contoured sidewall 112 or suction sidewall SS of the airfoil 102 in the chordwise direction CW and the spanwise direction SW. In exemplary embodiments, the plurality of protrusions 200 are defined downstream from a mid-point MP of the chord length 124 and upstream of the trailing edge 116 with respect to a primary airflow direction PAF from the leading edge 114 to the trailing edge 116 across the second contoured sidewall 112 or suction sidewall SS of the airfoil 102. In exemplary embodiments, the plurality of protrusions 200 are defined downstream from initiation line 120 and upstream of the trailing edge 116 with respect to the primary airflow direction PAF from the leading edge 114 to the trailing edge 116 across the second contoured sidewall 112 or suction sidewall SS of the airfoil 102. One or more of the protrusions can be metallic or nonmetallic. The protrusions can be introduced in full construction or as partial implants on the airfoil surface with uniform/biased distribution. Non dimensional space protrusions can be secondary bonded parts.

The plurality of protrusions 200 can be located/distributed along the entire span of the airfoil 102, arranged in arrays distributed spanwise along multiple chordwise CW positions or positioned in clusters or sets along the spanwise direction to optimize for aero and acoustics design and off design airflow conditions. In addition, the protrusions 200 can be formed on or applied to laminated, coated and braided airfoils. In a particular embodiment, one or more or all of the protrusions of the plurality of protrusions 200 is completely disposed downstream from the mid-point MP and each protrusion terminates at a point that is upstream from the trailing edge 116 of the airfoil 102.

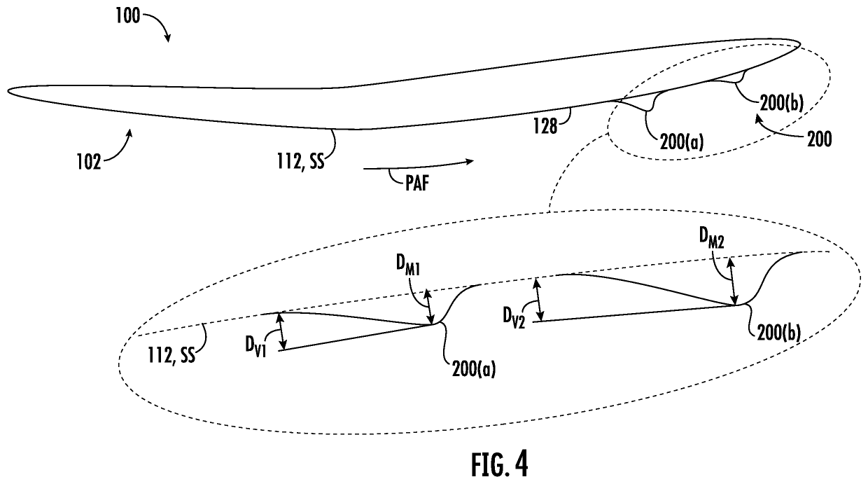

FIG. 4 is a schematic cross-sectioned view taken along section line 4-4 of FIG. 3 of a portion of the airfoil 102 as shown in FIG. 3, in accordance with an exemplary aspect of the present disclosure. In exemplary embodiments, as shown in FIGS. 3 and 4 collectively, the plurality of protrusions 200 disposed on the second contoured sidewall 112 or suction sidewall SS includes at least a first protrusion 200(a) and a second protrusion 200(b). In exemplary configurations, as shown in FIG. 3, the first protrusion 200(a) is offset from the second protrusion 200(b) in the spanwise direction. As shown in FIGS. 3 and 4 collectively, the first protrusion 200(a) is disposed and/or begins upstream from the second protrusion 200(b) with respect to the primary airflow direction PAF across the airfoil 102.

As shown in the enlarged portion view of FIG. 4, each protrusion 200(a), 200(b) of the plurality of protrusions 200 extends outwardly from the second contoured sidewall 112 or suction sidewall SS at a distance D_{V1}, D_{V2}, respectively that is variable as measured from a surface arc line or an outer surface 128 defined along the second contoured sidewall 112 or suction sidewall SS of the airfoil 102. The outer surface 128 extends in the chordwise direction CW (FIG. 3). In exemplary embodiments, distance D_{V1}, and distance D_{V2} also vary in the spanwise direction SW.

As shown in FIG. 4, the first protrusion 200(a) extends outwardly from the second contoured sidewall 112 or suction sidewall SS at a first maximum distance D_{M1} as measured from the outer surface 128, and the second protrusion 200(b) extends outwardly from the second contoured sidewall 112 or suction sidewall SS at a second maximum distance D_{M2} as measured from the outer surface 128. The first maximum distance D_{M1} may be greater than, less than or equal to the second maximum distance D_{M2} as measured from the outer surface 128. The first maximum distance D_{M1} and the second maximum distance D_{M2} are each measured from a line that is perpendicular to a point along the outer surface 128.

Referring back to FIG. 3, in exemplary embodiments, one or more protrusions of the plurality of protrusions 200 may be angled, turned, or otherwise oriented with respect to a top surface 130 of the platform 104 and/or with respect to a secondary airflow SAF across the second contoured sidewall 112 or suction sidewall SS. For example, as shown in FIG. 3, the plurality of protrusions 200 on the second contoured sidewall 112 or suction sidewall SS of the airfoil 102 includes one or more angled protrusion(s) 202 that are oriented, respectively at a respective angle Θ with respect to the top surface 130 of the platform 104.

In exemplary embodiments, the second contoured sidewall 112 or suction sidewall SS of the airfoil 102 includes at least two angled protrusions 202(a) and 202(b) that are oriented at angles Θ1 and Θ2, respectively, with respect to the top surface 130 of the platform 104. Angled protrusions 202(a) and 202(b) are positioned proximate to the platform 104. In this instance, the term “proximate” means that the angled protrusions 202(a), 202(b) are positioned closer to the top surface 130 of the platform 104 than to the tip portion 118 of the airfoil 102. In exemplary embodiments, at least one or more of angled protrusions 202 are positioned between point P defined at the mid-span location (half a distance of a total span length between the platform 104 and the tip portion 118) and the top surface 130 of the platform 104. In particular embodiments, angled protrusions 202(a), 202(b) may be curved or scooped upward towards the tip portion 118, downward towards the top surface 130 of the platform 104 or may have an undulating, or non-uniform shape as they extend towards the trailing edge 116 of the airfoil 102. It is to be appreciated that the plurality of protrusions 200 may include one, two or multiple angled protrusions 202.

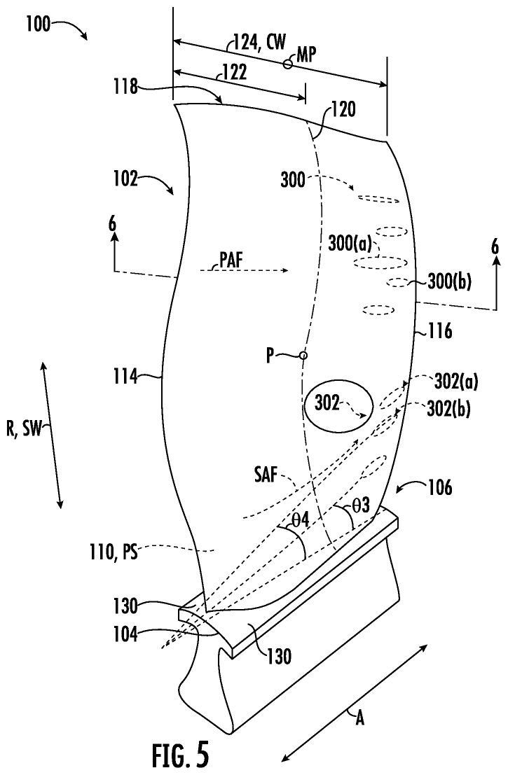

FIG. 5 is a perspective view of another embodiment of fan blade 100 that may be used as fan blade 52 in the turbofan engine 20 (shown in FIG. 2). In exemplary embodiments, the airfoil 102 includes a plurality of protrusions 300 (shown as dashed lines in FIG. 5) extending outwardly from the first contoured sidewall 110 or pressure sidewall PS of the airfoil 102 in the chordwise direction CW and the spanwise SW direction. In exemplary embodiments, the plurality of protrusions 300 are defined downstream from the mid-point MP of the chord length 124 and upstream of the trailing edge 116 with respect to the primary airflow direction PAF from the leading edge 114 to the trailing edge 116 across the first contoured sidewall 110 or pressure sidewall PS of the airfoil 102. In exemplary embodiments, the plurality of protrusions 300 are defined downstream from initiation line 120 and upstream of the trailing edge 116 with respect to the primary airflow direction PAF from the leading edge 114 to the trailing edge 116 across the first contoured sidewall 110 or pressure sidewall PS of the airfoil 102.

The plurality of protrusions 300 can be located/distributed along the entire span of the airfoil 102, arranged in arrays distributed spanwise along multiple chordwise positions or arranged in sets or clusters along the spanwise direction to optimize for aero and acoustics design and off design airflow conditions. In addition, the plurality of protrusions 300 can be formed on or applied to laminated, coated and braided airfoils. In particular embodiments, one or more or all of the protrusions of the plurality of protrusions 300 are formed or start downstream from the mid-point MP or initiation line 120 and terminate(s) upstream from the trailing edge 116 of the airfoil 102.

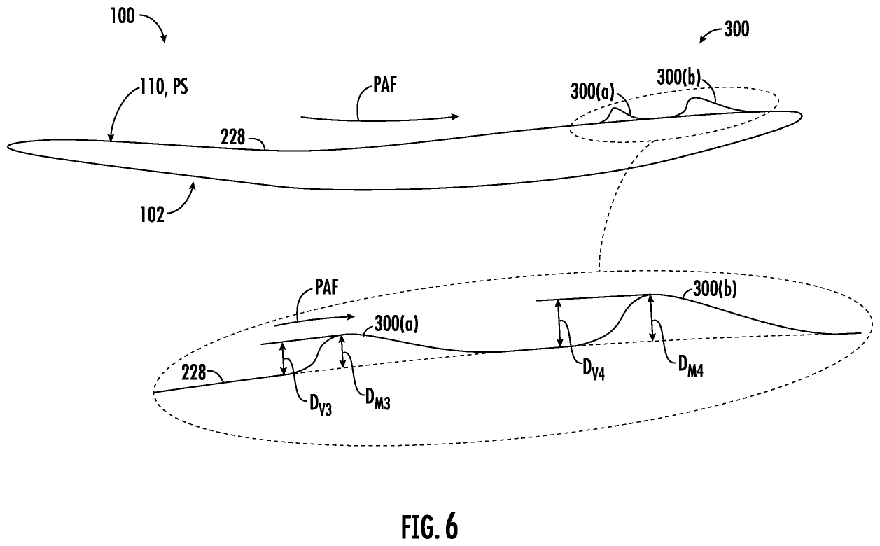

FIG. 6 is a schematic cross-sectioned view taken along section line 6-6 of FIG. 5 of a portion of the airfoil 102 as shown in FIG. 5, in accordance with an exemplary aspect of the present disclosure. In exemplary embodiments, as shown in FIGS. 5 and 6 collectively, the plurality of protrusions 300 disposed on the first contoured sidewall 110 or pressure sidewall PS includes at least a first protrusion 300(a) and a second protrusion 300(b). In exemplary configurations, as shown in FIG. 5, the first protrusion 300(a) is offset from the second protrusion 300(b) in the spanwise direction SW. As shown in FIGS. 5 and 6 collectively, the first protrusion 300(a) is disposed and/or begins upstream from the second protrusion 300(b) with respect to the primary airflow direction PAF across the airfoil 102.

As shown in the enlarged portion view of FIG. 6, each protrusion 300(a), 300(b) of the plurality of protrusions 300 extends outwardly from the first contoured sidewall 110 or pressure sidewall PS at a distance D_{V3}, D_{V4}, respectively that is variable as measured from a surface arc line or an outer surface 228 defined along the first contoured sidewall 110 or pressure sidewall PS of the airfoil 102. The outer surface 228 extends in the chordwise direction CW. In exemplary embodiments, distance D_{V3}, and distance D_{V4} also vary in the spanwise direction.

As shown in the enlarged portion of FIG. 6, the first protrusion 300(a) extends outwardly from the first contoured sidewall 110 or pressure sidewall PS at a third maximum distance DM3 as measured from the outer surface 228, and the second protrusion 300(b) extends outwardly from the first contoured sidewall 110 or pressure sidewall PS at a fourth maximum distance DM4 as measured from the outer surface 228. The third maximum distance DM3 may be greater than, less than or equal to the fourth maximum distance DM4 as measured from the outer surface 228. Maximum distance DM3 and maximum distance DM4 are each measured from a line that is perpendicular to a point along the outer surface 228.

Referring back to FIG. 5, in exemplary embodiments, one or more protrusions of the plurality of protrusions 300 may be angled, turned, or otherwise oriented with respect to the top surface 130 of the platform 104 and/or with respect to the secondary airflow SAF across the first contoured sidewall 110 or pressure sidewall PS. For example, as shown in FIG. 5, the plurality of protrusions 300 on the first contoured sidewall 110 or pressure sidewall PS of the airfoil 102 includes one or more angled protrusion(s) 302 that are oriented respectively at a respective angle Q with respect to the top surface 130 of the platform 104.

In exemplary embodiments, the first contoured sidewall 110 or pressure sidewall PS of the airfoil 102 includes at least two angled protrusions 302(a) and 302(b) that are oriented at angles Θ3 and Θ4 respectively with respect to the top surface 130 of the platform 104. Angled protrusions 302(a) and 302(b) are positioned proximate to the platform 104. In this instance, the term “proximate” means that the angled protrusions 302(a), 302(b) are positioned closer to the top surface 130 of the platform 104 than to the tip portion 118 of the airfoil 102. In exemplary embodiments, at least one or more of angled protrusions 302 are positioned between point P defined at the mid-span location (half a distance of a total span length between the platform 104 and the tip portion 118) and the top surface 130 of the platform 104. In particular embodiments, angled protrusions 302(a), 302(b) may be curved or scooped upward towards the tip portion 118, downward towards the top surface 130 of the platform 104 or may have an undulating, or non-uniform three-dimensional shapes as they extend towards the trailing edge 116 of the airfoil 102. It is to be appreciated that the plurality of protrusions 300 may include one, two or multiple angled protrusions 302.

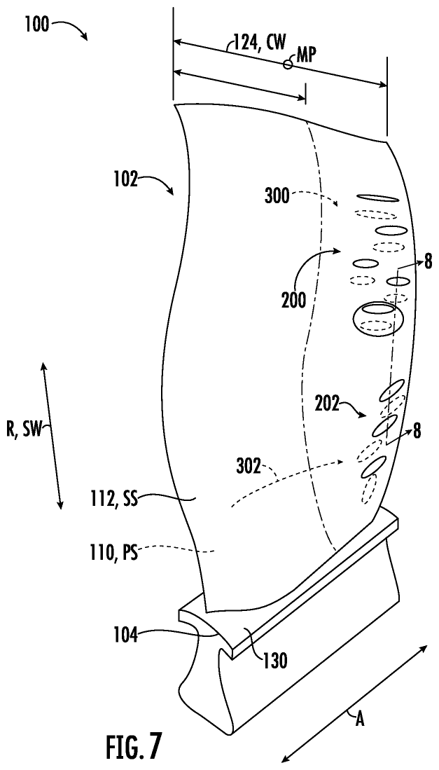

FIG. 7 is a perspective view of one embodiment of fan blade 100, 52 that may be used in the turbofan engine 20 (shown in FIG. 2). In exemplary embodiments, the airfoil 102 includes the plurality of protrusions 300 (shown as dashed lines in FIG. 7) extending outwardly from the first contoured sidewall 110 or pressure sidewall PS of the airfoil 102 in the chordwise direction CW and the spanwise direction SW. In the embodiments illustrated in FIG. 7, the airfoil 102 further includes the plurality of protrusions 200 (shown as solid lines in FIG. 7) extending outwardly from the second contoured sidewall 112 or suction sidewall SS of the airfoil 102 in the chordwise direction CW and the spanwise direction SW.

In an exemplary embodiment, as shown in FIG. 7, the plurality of protrusions 200, 300 include one or more angled protrusions 202, 302 disposed on one or on both of the second contoured sidewall 112 or suction sidewall SS, and/or the first contoured sidewall 110 or pressure sidewall PS. The angled protrusions 202, 302 shown in FIG. 7 may be shaped and sized as previously described herein and as illustrated in FIGS. 3-6.

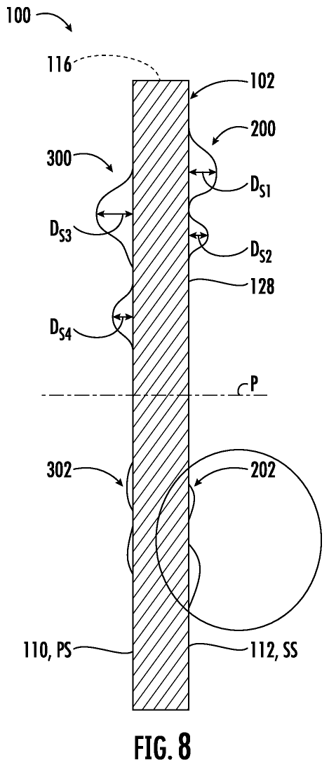

FIG. 8 provides a schematic cross-sectional view of a portion of exemplary fan blade 100 looking towards the trailing edge 116, in accordance with an exemplary aspect of the present disclosure. In certain configurations, as shown in FIG. 8, at least one protrusion 200 of the plurality of protrusions 200 extends outwardly from the outer surface 128 of the second contoured sidewall 112 or suction sidewall SS at a distance D_{S1} that is variable in the spanwise direction SW. In addition, or in the alternative, at least one protrusion 200 of the plurality of protrusions 200 extends outwardly from the outer surface 128 of the second contoured sidewall 112 or suction sidewall SS at a distance D_{S2} that is variable in the spanwise direction SW. D_{S1} may be greater than, less than or equal to D_{S2}.

In exemplary embodiments, as shown in FIG. 8, at least one protrusion 300 of the plurality of protrusions 300 extends outwardly from the outer surface 228 of the first contoured sidewall 110 or pressure sidewall PS at a distance D_{S3} that is variable in the spanwise direction SW. In addition, or in the alternative, at least one protrusion 300 of the plurality of protrusions 300, 302 extends outwardly from the outer surface 228 of the first contoured sidewall 110 or pressure sidewall SS at a distance D_{S4} that is variable in the spanwise direction SW. D_{S3} may be greater than, less than or equal to D_{S4}.

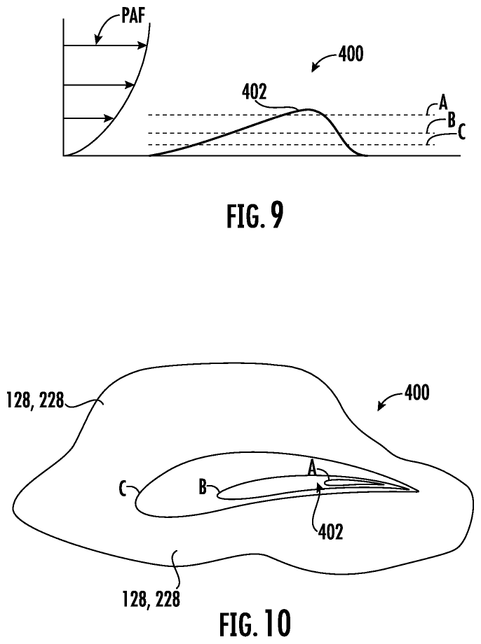

FIG. 9 provides a schematic top-down view of an exemplary protrusion 400 according to exemplary embodiments of the present disclosure. FIG. 10 provides a topographic view of protrusion 400 shown in FIG. 9 taken along elevation lines “A”, “B”, and “C”. Protrusion 400 may be exemplary of at least one protrusion 200 of the plurality of protrusions 200 on the suction sidewall SS or second contoured sidewall 112 and/or at least one protrusion 300 of the plurality of protrusions 300 on the pressure sidewall PS or the first contoured sidewall 110. As shown in FIG. 10, the protrusion 400 has a three-dimensional shape that may be tailored to a local boundary layer condition at a particular spot or location along the first or second contoured sidewall 110, 112. As shown, the airfoil camber at the protrusion 400 is highest nearest the respective outer surface 128, 228 (nearest section cut C) and progressively tapers towards tip 402 (nearest section cut A) to reduce camber monotonically from base to tip of the features. As previously mentioned, this 3D shaping of the protrusion(s) or feature provides the ability to optimize a loading distribution of aerodynamic pressure on the surfaces of the protrusions to generate streamwise vorticity of sufficient strength to mix the wakes that emanate from the airfoil and impinge on aerodynamic surfaces downstream with less magnitude of unsteadiness as compared to a conventional airfoil, thereby reducing the aeromechanical and aeroacoustic response of the downstream surfaces to these modified airfoil wakes generated by the protrusions 400.

FIG. 11 provides a top-down view of exemplary protrusions 500 according to an exemplary embodiment of the present disclosure. Protrusions 500 may be exemplary of the plurality of protrusions 200 on the suction sidewall SS or second contoured sidewall 112 and/or the plurality of protrusions 300 on the pressure sidewall PS or the first contoured sidewall 110. As show in FIG. 11, the protrusions 500 may extend outwardly from the respective outer surface 128, 228 in a combination of various distances. In particular embodiments, the protrusions 500 may be disposed along the respective outer surface 128, 228 at alternating distances D1, D2, D3, D4, etc . . . .

In particular embodiments, the plurality of protrusions 200 and 300 may be formed integrally with the airfoil 102 via additive manufacturing techniques, electroforming/laser machining, or may be added to an existing airfoil by adding secondary nonstructural members like strips or tapes. The plurality of protrusions 200 and 300 may be formed as symmetric/asymmetric shapes.

In various embodiments, as shown in FIGS. 3 through 11 collectively, the plurality of protrusions 200 and 300 are curvilinear, three-dimensionally shaped in both spanwise and chordwise directions. As previously discussed, the curvilinear shape allows for smoothly tapered fillets. Forming the protrusions 200, 300 and the airfoil 102 as a unitary body via additive manufacturing techniques, enables wake mixing vorticity generation with minimum corner flow losses and associated drag. Further, as compared to straight (i.e., flat, uncambered) or simple airfoil shapes, forming the vortex generating features as three-dimensional shapes maximizes the formation of streamwise vorticity through consideration of the flow velocity profile through the boundary layer.

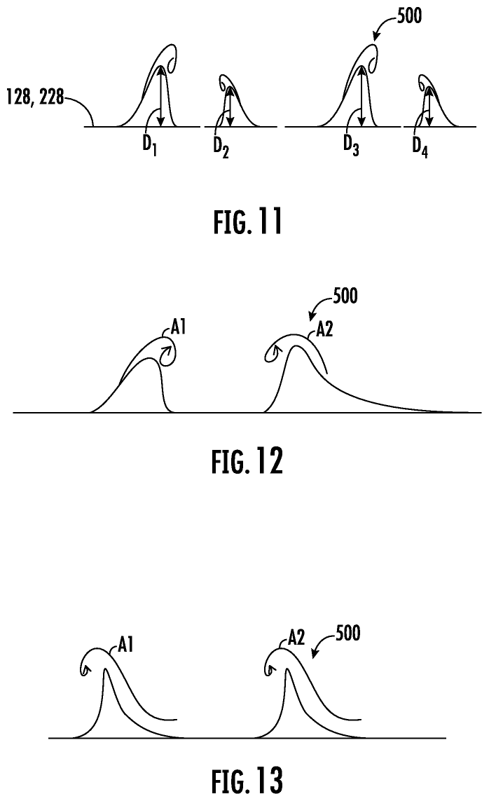

FIG. 12 provides a schematic top-down view of a pair of exemplary protrusions according to an exemplary embodiment of the present disclosure. The aerodynamic wake mixing enhancements provided by the protrusion features are beneficial in certain instances (such as for plane wakes emanating from the trailing edge in a predominantly streamwise direction without a significant degree of radial shear of the circumferential flow velocity) when the features are oriented to produce alternating directions of flow rotation show with arrows (A1) and (A2) about the vortices generated, as shown in FIG. 12. This is termed a counter-rotating pair or array of protrusions or vortex generators. FIG. 13 provides a schematic top-down view of a pair of exemplary protrusions 500 according to an exemplary embodiment of the present disclosure. In other instances, such as when there is a significant degree of spanwise [or secondary] flow for the blade design, the protrusions 500 may provide more optimal behavior when oriented to produce similar directions of flow rotation A1, A2 about vortices generated whilst also aiding to redirect to some degree the crossflow favorably towards the intended streamwise direction thereby reducing secondary flow losses, as illustrated in FIG. 13.

This written description uses examples to disclose the present disclosure, including the best mode, and to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clause:

An airfoil for a turbofan engine, the airfoil comprising: a first contoured sidewall, a second contoured sidewall, a leading edge, and a trailing edge, each extending in a spanwise direction defined between a root and a tip portion of the airfoil, wherein the first contoured sidewall and the second contoured sidewall define an outer surface of the airfoil; and a plurality of protrusions each protrusion of the plurality of protrusions having a curvilinear shape and extending outwardly from the outer surface along the first contoured sidewall or the second contoured sidewall, wherein the plurality of protrusions is defined downstream from a mid-point of a chord length of the airfoil and terminates upstream of the trailing edge.

The airfoil of the preceding clause, wherein the first contoured sidewall corresponds to a pressure sidewall of the airfoil, and the second contoured sidewall corresponds to a suction sidewall of the airfoil.

The airfoil of any preceding clause, wherein the plurality of protrusions includes a first protrusion and a second protrusion, wherein the first protrusion is disposed upstream from the second protrusion with respect to a primary airflow across the airfoil.

The airfoil of any preceding clause, wherein the plurality of protrusions includes a first protrusion and a second protrusion, wherein the first protrusion is offset from the second protrusion in the spanwise direction.

The airfoil of any preceding clause, wherein at least one protrusion of the plurality of protrusions extends outwardly from the outer surface of the airfoil at a distance that is variable in a chordwise direction.

The airfoil of any preceding clause, wherein at least one protrusion of the plurality of protrusions extends outwardly from the suction sidewall at a distance from the outer surface that is variable in the spanwise direction.

The airfoil of any preceding clause, wherein the airfoil is a fan blade.

The airfoil of any preceding clause, wherein the airfoil further comprises a plurality of protrusions extending outwardly from the pressure sidewall.

The airfoil of any preceding clause, wherein the plurality of protrusions further comprises at least one angled protrusion disposed closer to the platform than to the tip portion of the airfoil.

The airfoil of any preceding clause, wherein the plurality of protrusions includes a first protrusion and a second protrusion, wherein the first protrusion extends outwardly from the outer surface of the suction sidewall at a first maximum distance, and the second protrusion extends outwardly from the outer surface of the suction sidewall at a second maximum distance as measured from the outer surface.

The airfoil of any preceding clause, wherein the first protrusion is disposed upstream from the second protrusion with respect to the flow direction across the airfoil.

The airfoil of any preceding clause, wherein the first maximum distance is greater than the second maximum distance as measured from the outer surface.

The airfoil of any preceding clause, wherein the first maximum distance is less than the second maximum distance as measured from the outer surface.

The airfoil of any preceding clause, wherein the first maximum distance is equal to the second maximum distance as measured from the outer surface.

The airfoil of any preceding clause, wherein one or more protrusions of the plurality of protrusions is metallic.

The airfoil of any preceding clause, wherein one or more protrusions of the plurality of protrusions are non-metallic.

The airfoil of any preceding clause, wherein one or more protrusions of the plurality of protrusions are secondarily bonded to the airfoil.

The airfoil of any preceding clause, wherein one or more protrusions of the plurality of protrusions is oval, teardrop, or fin shaped.

A turbofan engine, comprising: an airfoil coupled to a shaft, the airfoil comprising: a first contoured sidewall, a second contoured sidewall, a leading edge, and a trailing edge, each extending in a spanwise direction defined between a root and a tip portion of the airfoil, wherein the first contoured sidewall and the second contoured sidewall define an outer surface of the airfoil; and a plurality of protrusions each protrusion of the plurality of protrusions having a curvilinear shape and extending outwardly from the outer surface along the first contoured sidewall or the second contoured sidewall, wherein the plurality of protrusions is defined downstream from a mid-point of a chord length of the airfoil and terminates upstream of the trailing edge.

The turbofan engine of the preceding clause, wherein the first contoured sidewall corresponds to a pressure sidewall of the airfoil, and the second contoured sidewall corresponds to a suction sidewall of the airfoil.

The turbofan engine of any preceding clause, wherein the plurality of protrusions includes a first protrusion and a second protrusion, wherein the first protrusion is disposed upstream from the second protrusion with respect to a primary airflow across the airfoil.

The turbofan engine of any preceding clause, wherein the plurality of protrusions includes a first protrusion and a second protrusion, wherein the first protrusion is offset from the second protrusion in the spanwise direction.

The turbofan engine of any preceding clause, wherein at least one protrusion of the plurality of protrusions extends outwardly from the outer surface of the airfoil at a distance that is variable in a chordwise direction.

The turbofan engine of any preceding clause, wherein the plurality of protrusions further comprises at least one angled protrusion disposed closer to the platform than to the tip portion of the airfoil

We claim:

1. An airfoil for a turbofan engine, the airfoil comprising:
a first contoured sidewall, a second contoured sidewall, a leading edge, and a trailing edge, each extending in a spanwise direction defined between a root and a tip portion of the airfoil, wherein the first contoured sidewall and the second contoured sidewall define an outer surface of the airfoil; and
a plurality of protrusions each protrusion of the plurality of protrusions having a curvilinear shape and extending outwardly from the outer surface along at least one of the first contoured sidewall or the second contoured sidewall, wherein the plurality of protrusions is defined downstream from a mid-point of a chord length of the airfoil and terminates upstream of the trailing edge.

2. The airfoil of claim 1, wherein the first contoured sidewall corresponds to a pressure sidewall of the airfoil, and the second contoured sidewall corresponds to a suction sidewall of the airfoil.

3. The airfoil of claim 1, wherein the plurality of protrusions includes a first protrusion and a second protrusion, wherein the first protrusion is disposed upstream from the second protrusion with respect to a primary airflow across the airfoil.

4. The airfoil of claim 1, wherein the plurality of protrusions includes a first protrusion and a second protrusion, wherein the first protrusion is offset from the second protrusion in the spanwise direction.

5. The airfoil of claim 1, wherein at least one protrusion of the plurality of protrusions extends outwardly from the outer surface of the airfoil at a distance that is variable in a chordwise direction.

6. The airfoil of claim 1, wherein at least one protrusion of the plurality of protrusions extends outwardly from the suction sidewall at a distance from the outer surface that is variable in the spanwise direction.

7. The airfoil of claim 1, wherein the airfoil is a fan blade.

8. The airfoil of claim 1, wherein the airfoil further comprises a plurality of protrusions extending outwardly from the pressure sidewall.

9. The airfoil of claim 1, wherein the plurality of protrusions further comprises at least one angled protrusion disposed closer to a platform of the airfoil than to the tip portion of the airfoil.

10. The airfoil of claim 1, wherein the plurality of protrusions includes a first protrusion and a second protrusion, wherein the first protrusion extends outwardly from the outer surface of the suction sidewall at a first maximum distance, and the second protrusion extends outwardly from the outer surface of the suction sidewall at a second maximum distance as measured from the outer surface.

11. The airfoil of claim 10, wherein the first protrusion is disposed upstream from the second protrusion with respect to the flow direction across the airfoil.

12. The airfoil of claim 10, wherein the first maximum distance is greater than the second maximum distance as measured from the outer surface.

13. The airfoil of claim 10, wherein the first maximum distance is less than the second maximum distance as measured from the outer surface.

14. The airfoil of claim 10, wherein the first maximum distance is equal to the second maximum distance as measured from the outer surface.

15. A turbofan engine, comprising:
an airfoil coupled to a shaft, the airfoil comprising:
a first contoured sidewall, a second contoured sidewall, a leading edge, and a trailing edge, each extending in a spanwise direction defined between a root and a tip portion of the airfoil, wherein the first contoured sidewall and the second contoured sidewall define an outer surface of the airfoil; and
a plurality of protrusions each protrusion of the plurality of protrusions having a curvilinear shape and extending outwardly from the outer surface along at least one of the first contoured sidewall or the second contoured sidewall, wherein the plurality of protrusions is defined downstream from a mid-point of a chord length of the airfoil and terminates upstream of the trailing edge.

16. The turbofan engine of claim 15, wherein the first contoured sidewall corresponds to a pressure sidewall of the airfoil, and the second contoured sidewall corresponds to a suction sidewall of the airfoil.

17. The turbofan engine of claim 15, wherein the plurality of protrusions includes a first protrusion and a second protrusion, wherein the first protrusion is disposed upstream from the second protrusion with respect to a primary airflow across the airfoil.

18. The turbofan engine of claim 15, wherein the plurality of protrusions includes a first protrusion and a second protrusion, wherein the first protrusion is offset from the second protrusion in the spanwise direction.

19. The turbofan engine of claim 15, wherein at least one protrusion of the plurality of protrusions extends outwardly from the outer surface of the airfoil at a distance that is variable in a chordwise direction.

20. The turbofan engine of claim 15, wherein the plurality of protrusions further comprises at least one angled protrusion disposed closer to the platform than to the tip portion of the airfoil.
